(19) United States
(12) Patent Application Publication
(10) Pub. No.: US 2015/0363880 A1
(43) Pub. Date: Dec. 17, 2015

(54) Systems and Methods for Allocating Quantities in a Marketplace

(71) Applicant: TERA ADVANCED TECHNOLOGIES, LLC, Summit, NJ (US)

(72) Inventors: Daniel Droste, Hattingen (DE); Christian D. Martin, Morristown, NJ (US); Leonard T. Nuara, Summit, NJ (US)

(21) Appl. No.: 14/763,633

(22) PCT Filed: Jan. 28, 2014
(86) PCT No.: PCT/US14/13342

§ 371 Date: Jul. 27, 2015

Related U.S. Application Data
(60) Provisional application No. 61/758,270, filed on Jan. 29, 2013.

(51) Int. Cl. G06Q 40/04

(52) U.S. Cl. CPC G06Q 40/04

(57) ABSTRACT

A participant in a marketplace may direct an order to buy or sell an item to a targeted participant with whom the former has a pre-existing relationship to enable access to additional quantities, capacity, or liquidity. The targeted participant may similarly offer to buy or sell such items in various pre-designated quantities at set prices to participants with whom it has a pre-existing relationship. These functions may be achieved while maintaining order and price transparency in the marketplace.

### CROSS-REFERENCE TO RELATED APPLICATION

This application claims the benefit of U.S. Provisional Patent Application Ser. No. 61/758,270, filed Jan. 29, 2013.

### TECHNICAL FIELD

Financial instrument trading and electronic commerce.

### BACKGROUND ART PER PCT RULE 5.1(a)(ii)

U.S. Pat. App. Pub. No. 2007/0078753 (Cormack et al.)
U.S. Pat. App. Pub. No. 2013/0013481 (Cooper)
U.S. Pat. No. 7,587,346 (Malitzis)
U.S. Pat. No. 7,801,795 (Nunes et al.)
U.S. Pat. No. 7,949,596 (Adcock et al.)
U.S. Pat. No. 8,296,216 (Furbush et al.)
U.S. Pat. No. 8,301,539 (Furbush et al.)
U.S. Pat. No. 8,311,930 (Adcock et al.)

### DISCLOSURE OF INVENTION

(Per PCT Rule 5.1(b), see Description of the Invention, below.)

### BRIEF DESCRIPTION OF THE DRAWINGS

FIGS. 1 and 2 are illustrations of directed buy and sell order records, respectively;

FIGS. 3 and 4 are illustrations of sell and buy order records, respectively, from a targeted participant, identifying relationship participants and specifying allocated quantities;

FIGS. 5 and 6 illustrate a series of buy and sell order records, respectively, from a targeted participant for varying quantities and prices;

FIGS. 7 and 8 are a block diagram and a flow chart of the operation, respectively, of the directed order qualification processor of a directed order transaction system qualifying a directed buy order;

FIGS. 9 and 10 are a block diagram and a flow chart of the operation, respectively, of the order execution processor of a directed order transaction system executing a qualified directed buy order;

FIGS. 11 and 12 are a block diagram and a flow chart of the operation, respectively, of the directed order qualification processor of a directed order transaction system, illustrating the qualification operation when a targeted participant offers a quantity less than that sought for purchase in the directed order;

FIGS. 13 and 14 are a block diagram and a flow chart of the operation, respectively, of the order execution processor of a directed order transaction system, illustrating the execution operation when a targeted participant offers a quantity less than that sought for purchase in the directed order;

FIGS. 15 and 16 are a block diagram and a flow chart of the operation, respectively, of the order execution processor of a directed order transaction system, illustrating the operation when the targeted participant offers to purchase a quantity less than that initially offered in a directed sell order;

FIGS. 17 and 18 are a block diagram and a flow chart of the operation, respectively, of a directed order qualification and order execution system illustrating the processing of a directed buy order;

FIGS. 19 and 20 are a block diagram and a flow chart of the operation, respectively, of a directed order qualification and order execution system illustrating the processing of a directed sell order;

FIGS. 21 and 22 are a block diagram and a flow chart of the operation, respectively, of an order execution processor;

FIGS. 23 and 24 are a block diagram and a flow chart of the operation, respectively, of an order execution processor for an alternative directed order transaction system, illustrating the execution of a directed buy order;

FIGS. 25 and 26 are a block diagram and a flow chart of the operation, respectively, of an alternative directed order transaction system, illustrating the execution of a directed buy order;

FIGS. 27 and 28 are a block diagram and a flow chart of the operation, respectively, of an order execution processor for an alternative directed order transaction system, illustrating the execution of a directed sell order; and

FIGS. 29 and 30 are a block diagram and a flow chart of the operation, respectively, of an alternative directed order transaction system, illustrating the execution of a directed sell order.

### DESCRIPTION OF THE INVENTION

Although the price and frequently the quantity of items available for sale or purchase in a marketplace must necessarily be displayed to everyone, some participants prefer to limit the quantity displayed to avoid price dislocations. Further, one participant, the “relationship participant,” may have a preexisting relationship with another participant, the “targeted participant,” and the targeted participant may wish to offer certain additional quantities to the relationship participant. The directed order platform described here will achieve this goal.

Throughout the following discussion, the transactions will concern the sale of a particular item or commodity. Although the transactions outlined here are fashioned as purchases and sales of an item, these systems and methods may be used in a market entertaining bids and offers for financial instruments and securities, including commodities, equities, futures, options, swaps, and other financial contracts, at varying degrees of availability or liquidity. Further, while a single price is used for discussion purposes, a market may have separate prices for bids and offers, such that a participant may be willing to purchase an item at one price and sell the same item at a second price, creating a spread between the bids and offers (or bid and ask prices). For simplicity, prices and quantities for all of the parties are denoted by the letters p and q. The transactions discussed below and illustrated in the drawings may be executed sequentially and may be performed in price and time priority.

Through a directed order, a relationship participant in a marketplace may seek to purchase a pre-determined quantity of an item from a targeted participant, the party with which there is a preexisting relationship. In this role, the targeted participant functions as a market maker or a liquidity provider. Conversely, the relationship participant may wish to sell a pre-determined quantity of this item to the targeted participant.

The targeted participant's displayed availability is used along with the displayed availability of other participants to satisfy or meet the demand in the marketplace for purchase or sale of that item at the agreed-upon price. Subsequently, the targeted participant may then sell or purchase any unfilled quantity to the originator of the directed order, subject to any quantity limits imposed by the targeted participant. The targeted participant may control the amount, quantity, or liquidity it wishes to provide to the relationship participant.

In one arrangement, a qualification processor determines the quantity available for purchase from, or sale to, the targeted participant and optionally the credit-worthiness of the requesting relationship participant, and forwards a qualified directed order to an order execution processor. In another arrangement, the directed order proceeds directly to an order execution processor, which in turn executes the order, first with the displayed quantities and thereafter with additional quantities stated in the order as made available by a targeted participant.

This technology may be implemented on any suitable, commercially-available computer or computer system, utilizing any desired operating system. It may also be implemented in dedicated hardware such as application specific integrated circuits (ASICs), field-programmable gate arrays (FPGAs), and custom-designed and fabricated hardware.

The Directed Order

A directed order to buy (or bid) may be created by providing the identity of the relationship participant (in this example, “p1”), the item sought, the price p the participant is willing to pay for the item, quantity q, and the identity of the targeted participant to whom the order is directed (e.g., p3), as illustrated by the buy order record 10 shown in FIG. 1. As illustrated in the record of FIG. 1, the relationship participant p1 may direct the order to more than one targeted participant, such as the targeted participant p8.

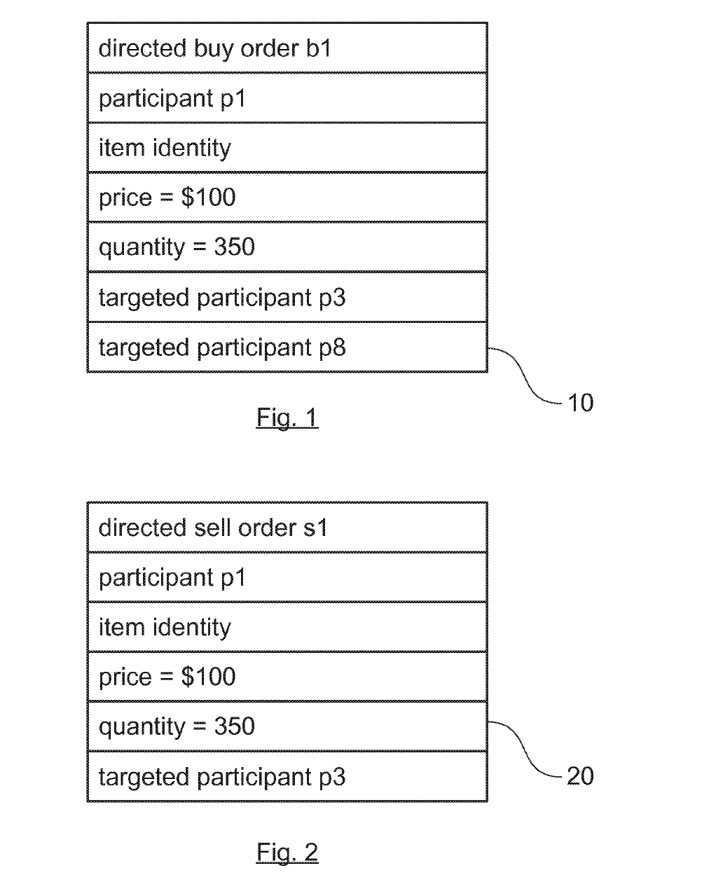

Similarly, a directed order may be employed to sell (or offer) an item. As illustrated by the sell order record 20 shown in FIG. 2, a directed order to sell may be created by providing the identity of the relationship participant (in this example, “p1”), the item sought, the price p the participant is willing to accept for the item, quantity q, and the identity of the targeted participant to whom the order is directed (e.g., p3).

The Variable Quantity or Liquidity Order

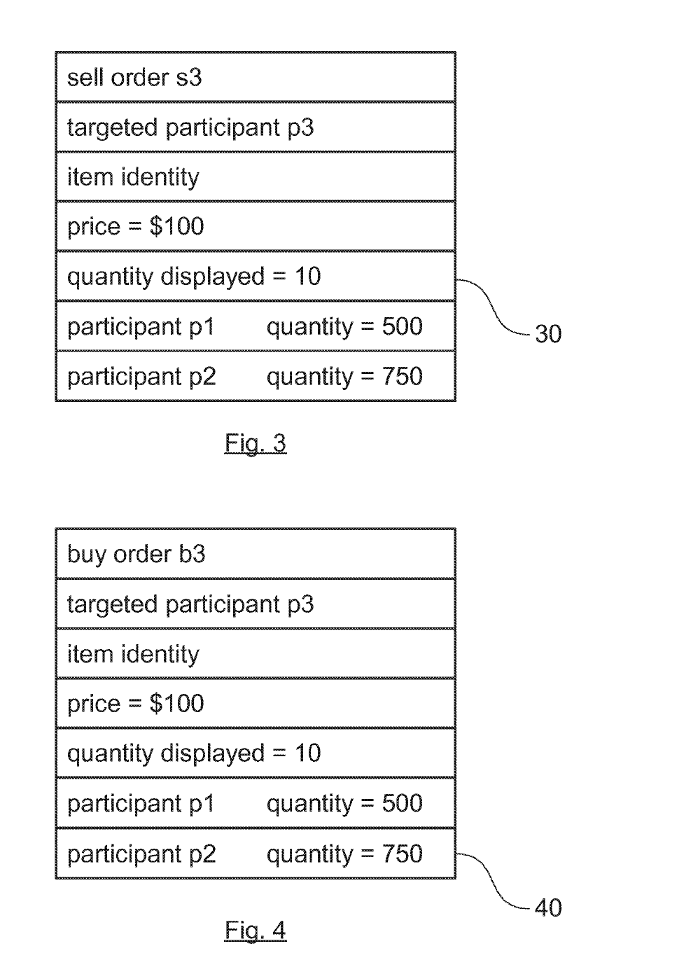

The targeted participant may structure the availability, inventory, or liquidity responsive to a directed order in a variety of ways. As shown in the sell order record 30 in FIG. 3, the targeted participant would provide its identity (here “p3”), the identity of the item it is selling (or offering), the price p, and a quantity q the targeted participant is willing to display and offer to everyone. The targeted participant p3 would further identify the relationship participants to whom it is willing to sell (or offer) specified quantities of the item, such as p1 and p2 identified in FIG. 3.

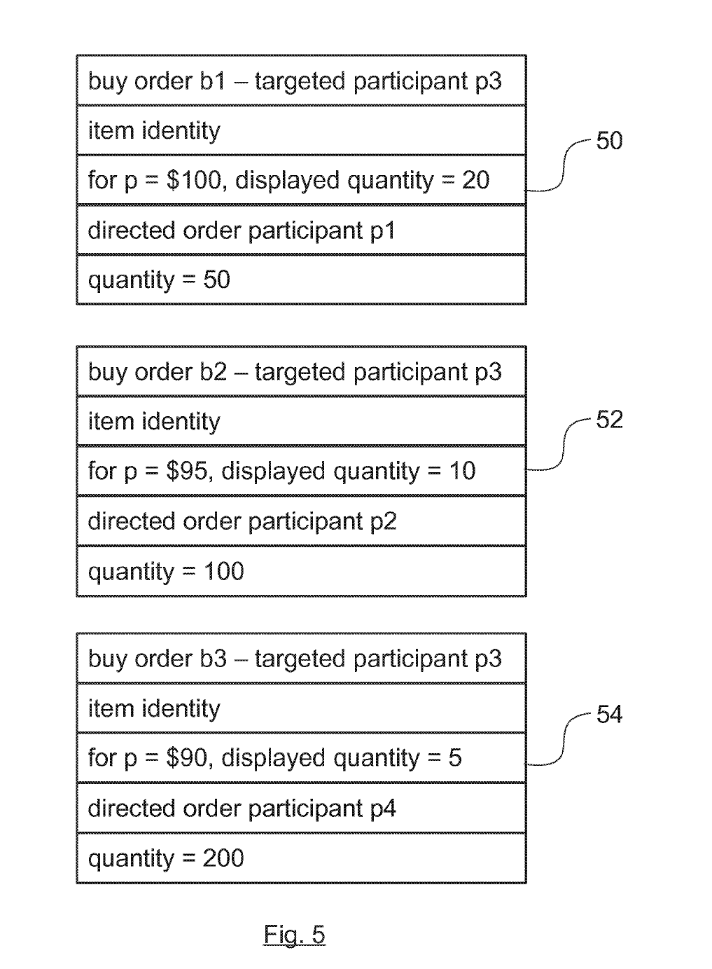

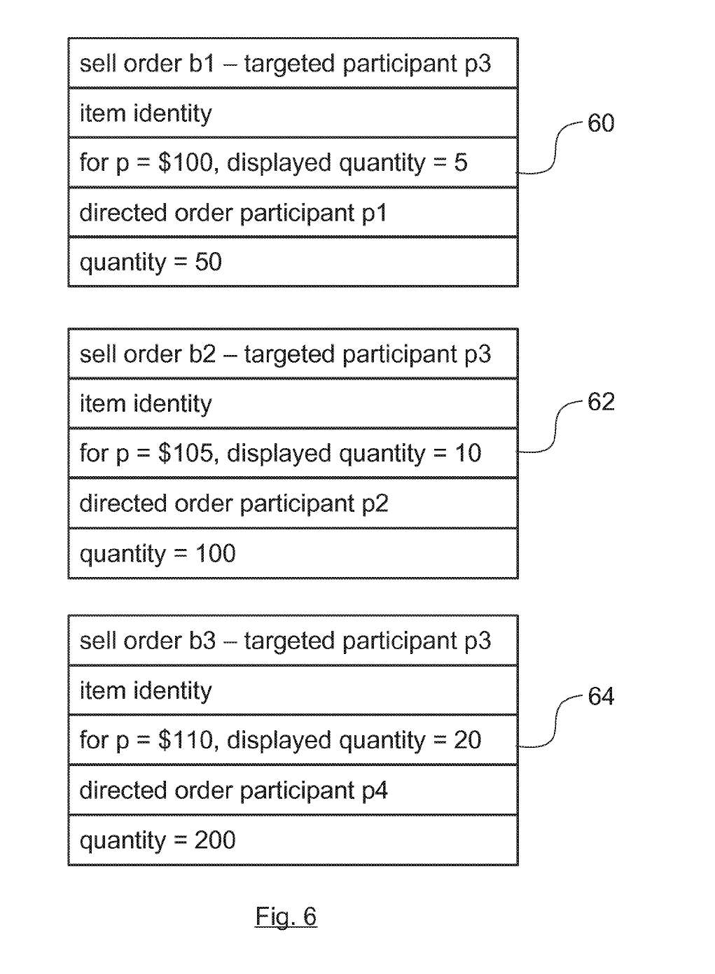

Through a buy order 40, the targeted participant may offer to purchase an item, as illustrated in FIG. 4. The targeted participant would provide its identity (here “p3”), the identity of the item it is buying, the price p, and a quantity q the targeted participant is willing to display and offer to everyone. The targeted participant p3 would further identify the relationship participants from whom it is willing to buy (or bid) specified quantities of the item. As illustrated in buy orders b1-b3 (50, 52, 54) in FIG. 5 and in sell orders s1-s3 (60, 62, 64) in FIG. 6, the targeted participant may arrange to buy or sell the items in quantities displayed in the marketplace and prices as well as in non-displayed quantities to various relationship participants, or it may offer items to a single relationship participant in various quantities at different prices through multiple orders. Alternatively, the targeted participant may arrange to offer quantities to members of a pre-defined class or type of user (e.g., a brokerage, broker-dealer, government body, municipality), as opposed to specifically defined individual participants. The targeted participant could also structure offers based upon factors such as trading or purchasing history or volume, geographical location, and financial performance.

Qualifying the Directed Order

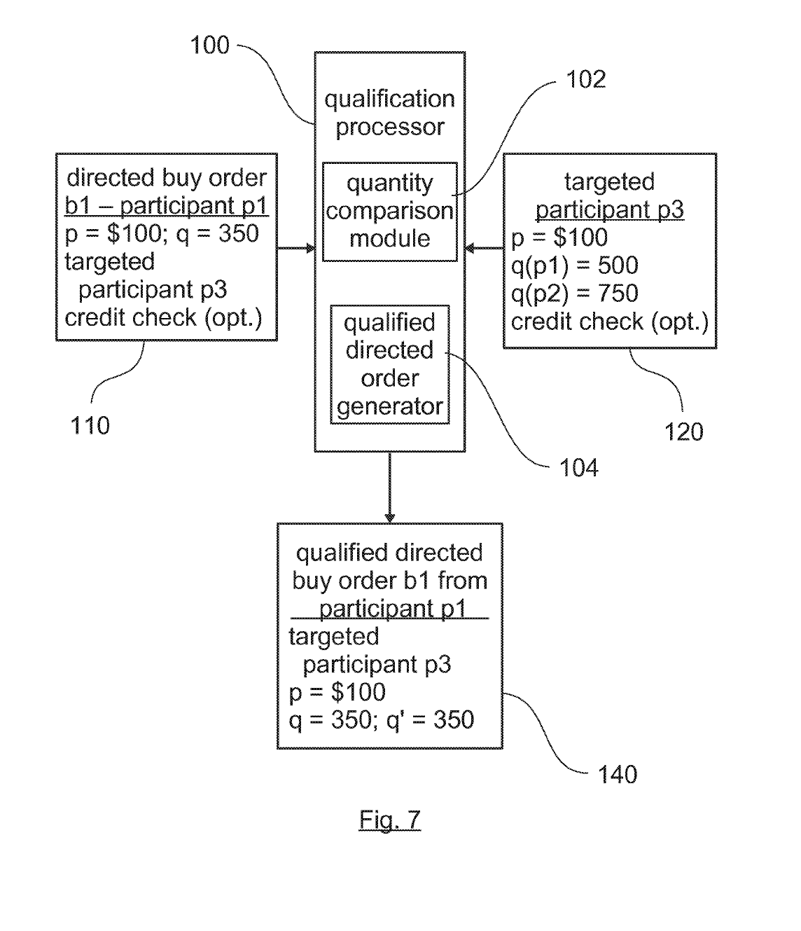

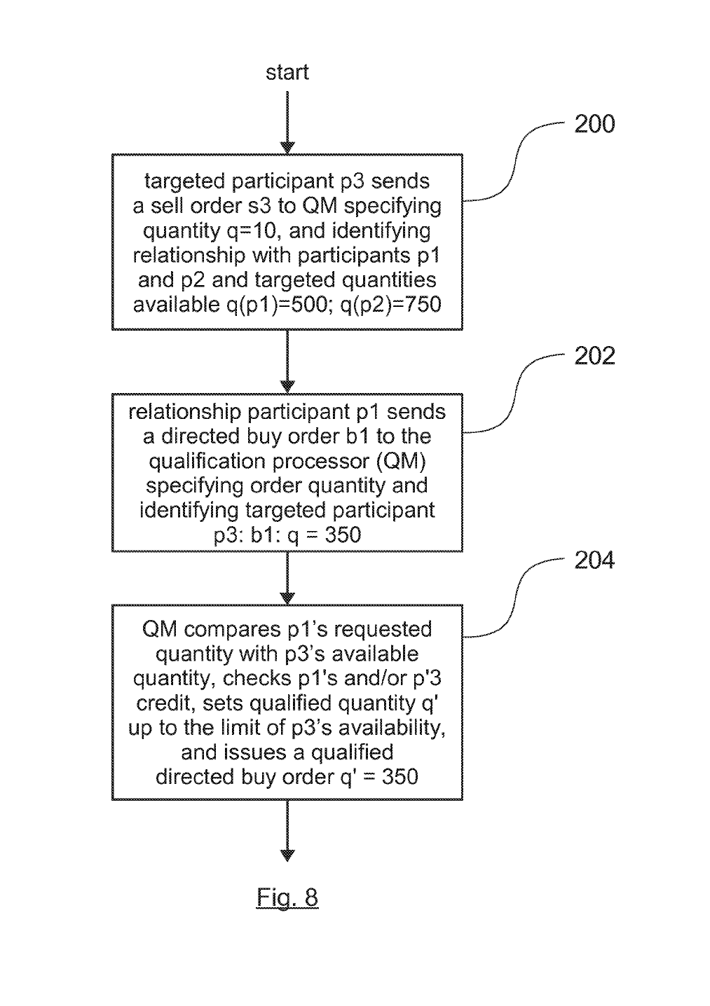

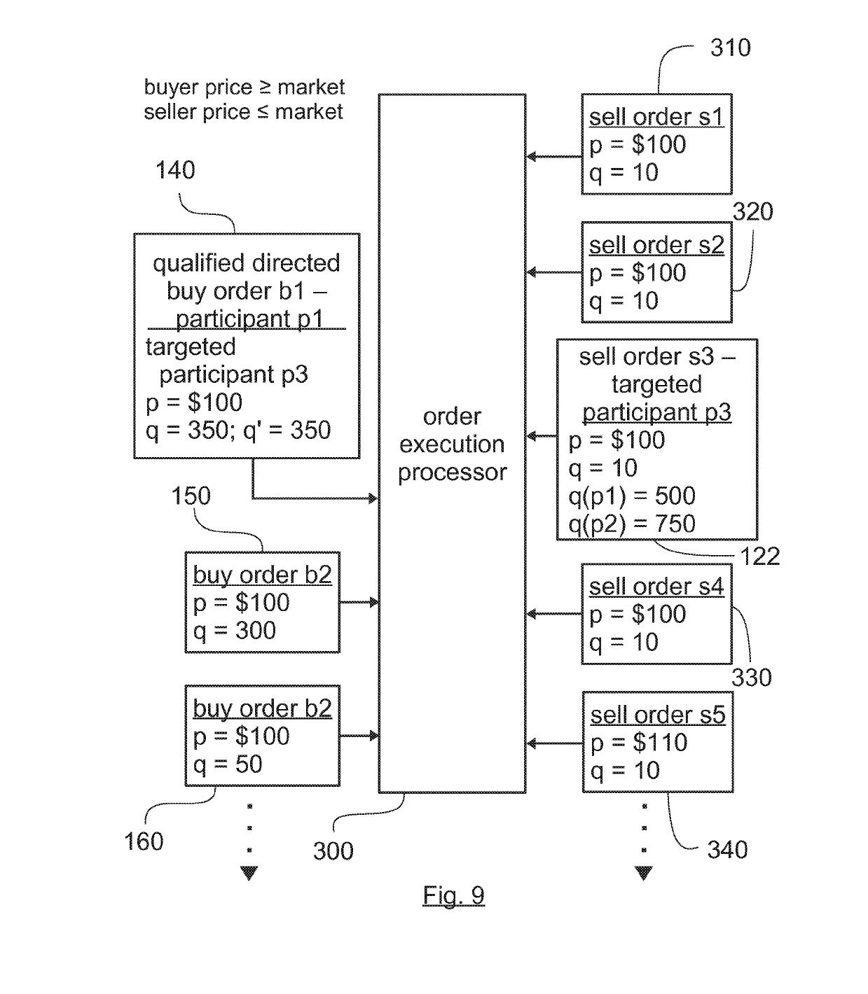

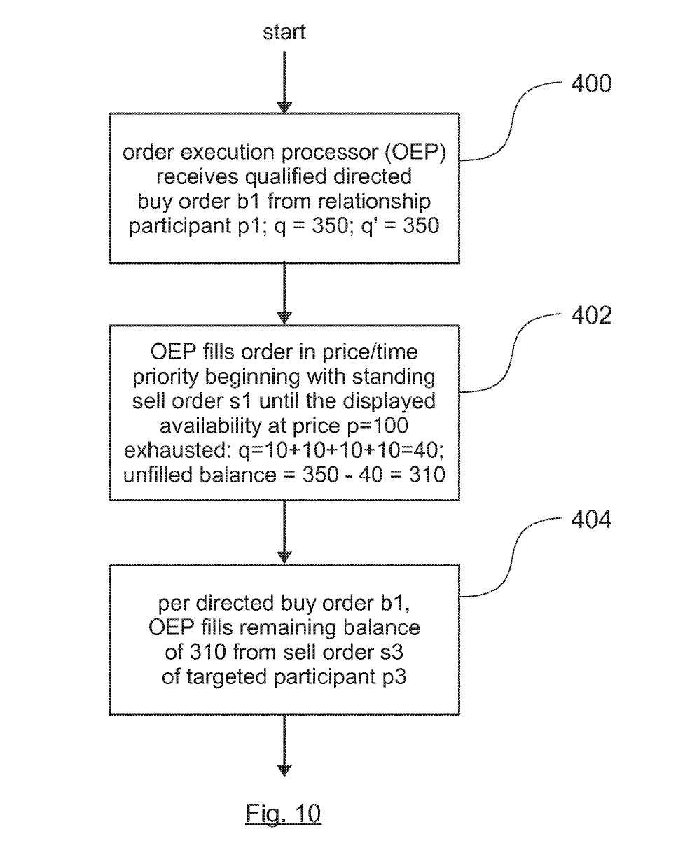

Before the relationship participant's directed buy or sell order is sent for execution, a qualification processor 100 may be employed to determine the amount of additional quantity or liquidity allocated to a relationship participant by a targeted participant. In the example shown in FIG. 7, the targeted participant p3 would send a quantity information record 120 to the qualification processor 100, stating it is willing to sell additional units to the relationship participant p1, in this case q(b1) is 500, at a price of p=100. The quantity information record 120 may also indicate additional quantities allotted to other participants such as p2 in the example in FIG. 7 (FIG. 8, step 200). Alternatively, the qualification processor 100 could extract the targeted participant's quantity information from a sell order record, or a buy order record in the case of a directed sell order. Subsequently, the relationship participant p1 would present a directed buy order b1 (110) directed to targeted participant p3, in this example seeking a quantity of 350 at a price p=100 (FIG. 8, step 202).

A quantity comparison module 102 in the qualification processor 100 compares the buy and sell order quantities and determines the quantity available to the relationship participant, and a qualified directed order generator 104 issues a qualified directed buy order 140, stating the quantity sought q of 350, and the qualified quantity q′ of 350, since q(b1) of 500 is greater than relationship participant p1's initial request for a q of 350, at price of p=100 (FIG. 8, step 204).

The qualification processor 100 may also determine whether one or both of the participants meet predetermined credit criteria. Factors that may be considered may include a participant's credit-worthiness, the notional value of the transaction, the net present value, and dollar duration (DV01), as well as other factors depending on the industry and the nature of the transaction.

Executing the Directed Order

Before the relationship participant's qualified directed buy order 140 arrives in the marketplace, an order execution processor 300 will have received sell order information from orders generated by participants offering the item sought by the relationship participant b1, identified in FIG. 9 as sell orders s1-s5 (310, 312, 122, 330, 340). The qualified directed buy order 140 is then received by the order execution processor 300 in FIG. 9 (FIG. 10, step 400), along with other buy orders b2 and b3 (150, 160) similarly generated by other participants in the marketplace. The buy and sell orders may be ranked in price/time priority and, although not shown, there may also be orders above and below the buy and sell orders illustrated in the figure at correspondingly higher and lower prices.

The order execution processor 300 will execute the sales, and may do so sequentially, starting with standing sell order s1 and capturing every unit available and displayed in other standing sell orders in the marketplace having a price of p=100 (or lower if lower priced units were displayed). In the example shown here, the order execution processor 300 will stop at s4 (330), since sell order s5 (340) seeks a price above that which participant p1 is willing to pay, thus completing the sale of 40 units (s1+s2+s3+s4), leaving an unfilled balance for relationship participant p1 of 310 units (FIG. 10, step 402). Buy orders b2 and b3 (150, 160) are not filled because the directed buy order 140 takes all of the quantities displayed in the marketplace at a price of p=100.

The order execution processor 300 will now return to the directed buy order 140 which states that 350 additional items are available from targeted participant p3. Since sell order s3 (122) is within the group of sell orders displaying quantities at a matching price (i.e., a price not higher than the participant was willing to pay), the order execution processor 300 will complete the 310-item balance of the order from s3's additional quantities (FIG. 10, step 404).

Directed Orders in the Case of Reduced Availability

Directed Buy Order

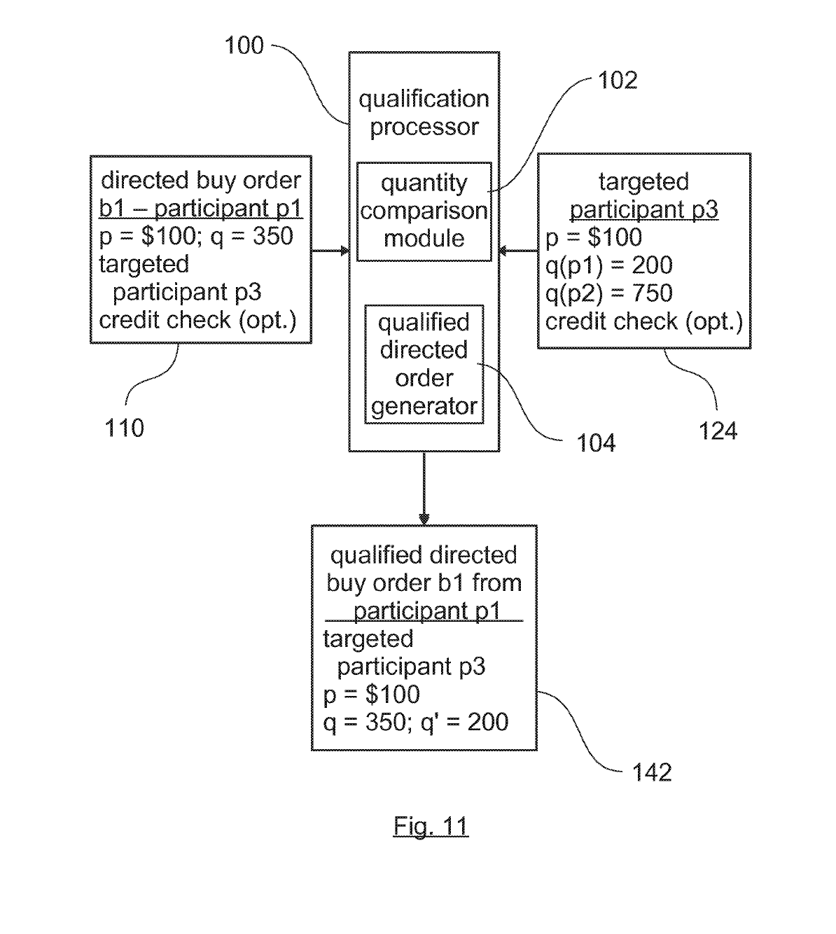

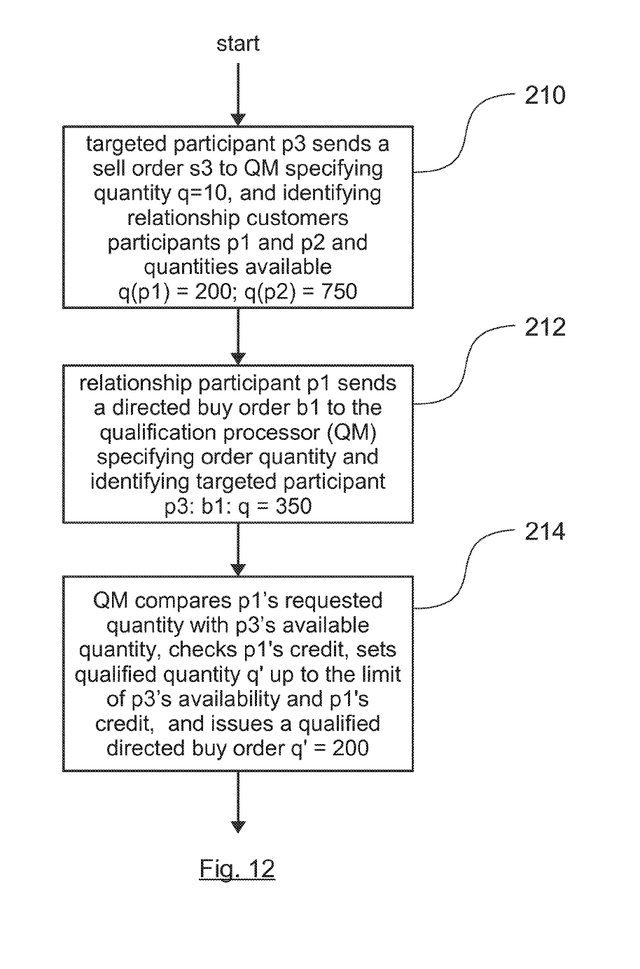

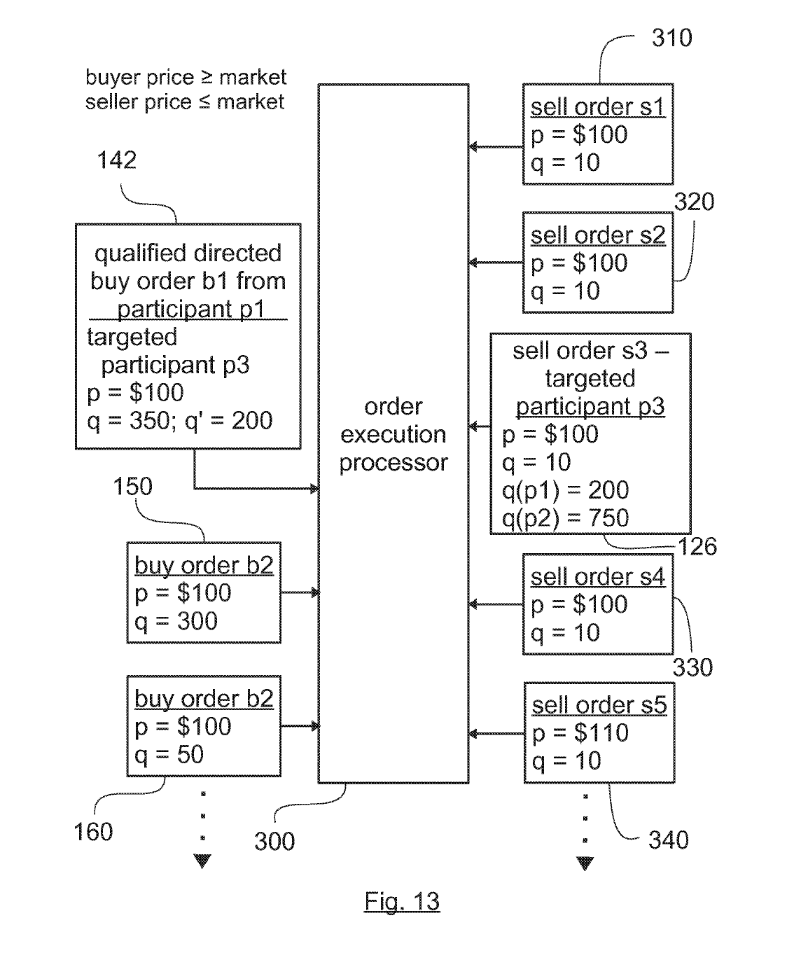

In the directed buy order scenario of FIGS. 7-10, the targeted participant p3 was willing to satisfy relationship participant p1's entire order. The same system and methods are again shown in FIGS. 11-14 where the targeted participant p3 also offers additional items but in a quantity less than that sought by the relationship participant. Referring to FIG. 11, compare relationship participant p1's quantity q=350 in directed buy order b1 (110) with the targeted participant p3's designation of 200 units for relationship participant p1 in quantity information record 122. In such a case, as shown in FIG. 11 and described in steps 210-214 in the flow chart in FIG. 12, the qualified directed order generator 104 issues a qualified directed buy order 142 with a total quantity of q=350 and a qualified quantity of q′=200 (FIG. 12, step 214).

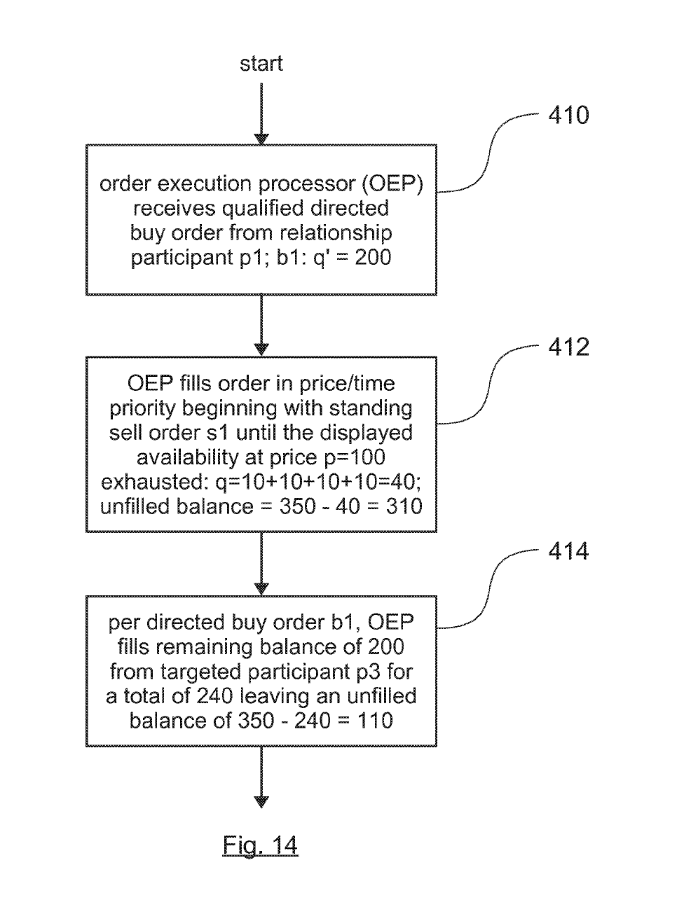

Upon receipt of the qualified directed buy order 142, the order execution processor 300 in FIG. 13 will seek all units displayed in standing sell orders in the marketplace having a price of p=100 (or lower), taking units from standing sell orders s1-s4 (310, 320, 126, 330), but not the higher-priced units of sell order s5 (340), leaving a first unfilled balance of 310 (FIG. 14, step 412). As directed by the qualified directed buy order 142, the order execution processor 300 will now take 200 units from the sell order s3 of targeted participant p3, leaving a second unfilled balance of 350−240=110 (FIG. 14, step 414). As occurred with the scenario of FIG. 9, buy orders b2 and b3 (150, 160) are not filled because directed buy order 142 takes all of the quantities displayed in the marketplace at a price of p=100.

A directed order may also include instructions concerning its pendency in the marketplace. If the directed order is allowed to stand, it will remain until filled by other orders not presently in the marketplace or it expires. Otherwise, the remaining quantity of the directed order may be structured to expire immediately after partial fulfillment by an order in the marketplace.

A directed order may also be directed to multiple targeted participants, as shown in FIG. 1, either in time order or in a predetermined order of preference. Execution of the directed order may also be conditioned on complete fulfillment by one or more parties.

Directed Sell Order

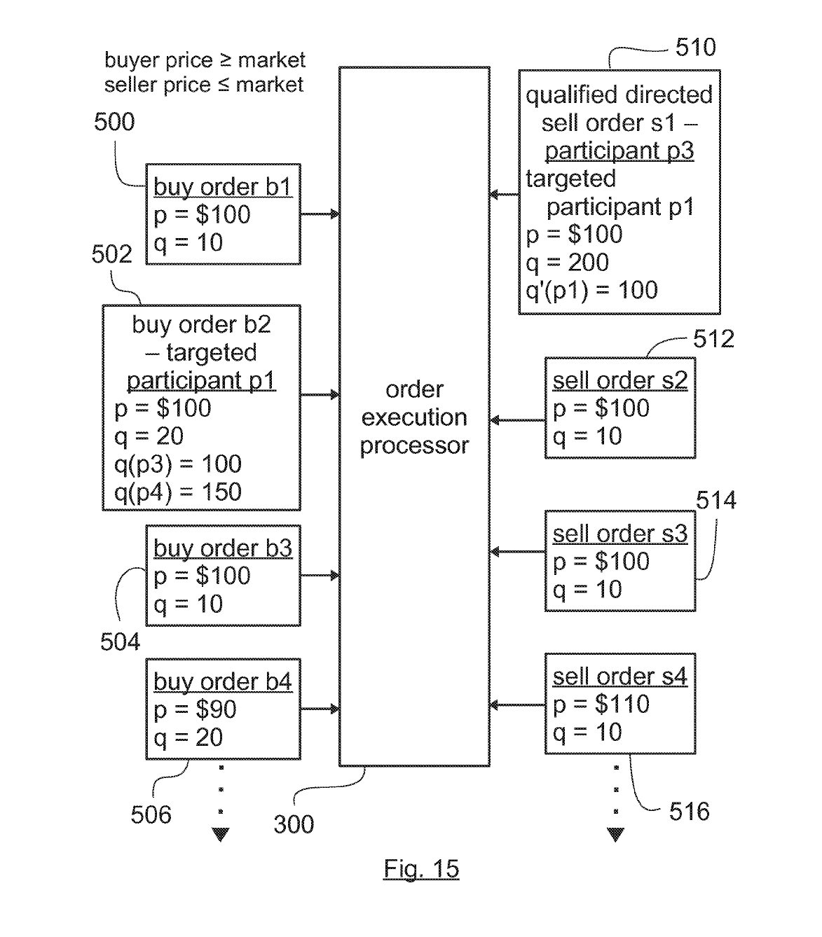

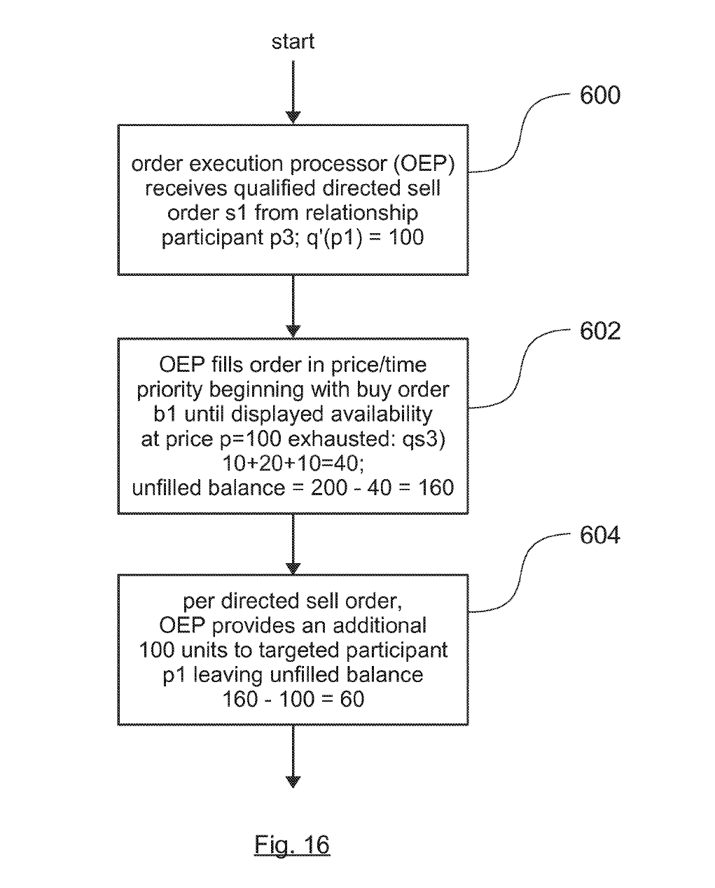

While the previous discussion concerned a directed buy order, the execution of a qualified directed sell order is shown in FIG. 15 and the flow chart in FIG. 16. Through sell order s1 (510), the relationship participant p3 seeks to sell a quantity of 200 at a price of $100 to the market. In a buy order b2 (502), a targeted participant p1 is willing to accept a maximum of 100 from the relationship participant p3 (FIG. 16, 600).

After the directed sell order has been qualified, indicating a quantity q′(p1) of 100, the order execution processor 300 processes the buy and sell orders, executing standing buy orders b1, b2, and b3 (500, 502, 504) at a price of $100 through sell order s1 (510), for a quantity of 40 units (10+20+10), and leaving a balance of 160 units (FIG. 16, 602). Buy order b4 (506) seeks units at a lower price of $90 and thus remains unfilled; sell orders s2 and s3 (512, 514) are not executed as the directed sell order s1 (510) uses all of the displayed buy quantities. Because of the pre-existing relationship between the relationship participant p1 and the targeted participant p3, an additional 100 units will be transferred to relationship participant p1 (FIG. 16, 604).

A Processing System for Qualification and Execution

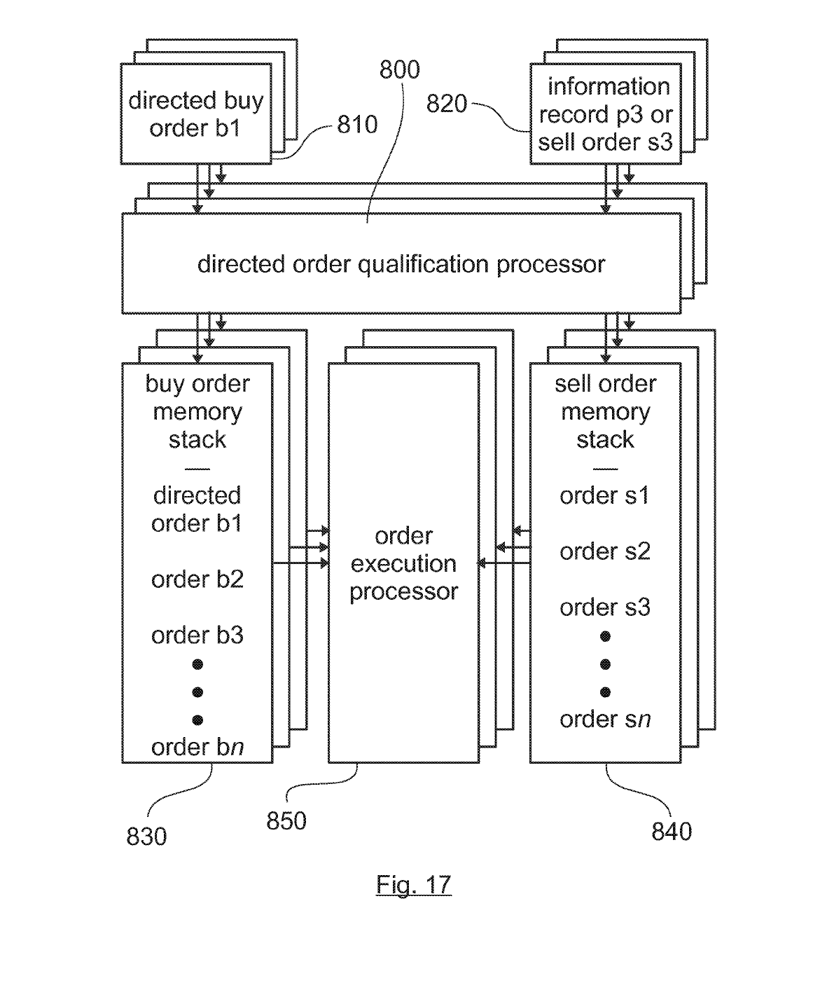

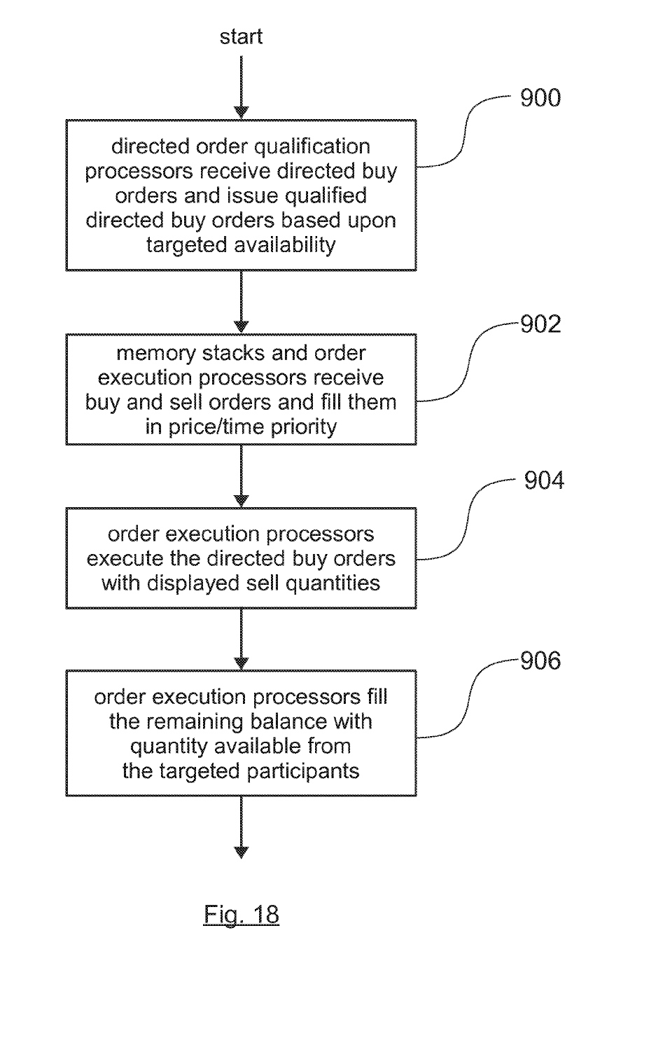

A block diagram of a processing system for directed order qualification and execution is shown in FIG. 17 and a corresponding flow chart is shown in FIG. 18. Multiple qualification and order execution processors are illustrated in FIG. 17 to provide for the processing of transactions for multiple items in parallel. In FIG. 17, directed order qualification processors 800 receive directed buy orders 810 and quantity information records from targeted participants (not shown) from targeted participants generating sell orders 820. As explained previously in the examples of FIGS. 7 and 11, the directed order qualification processors 800 compare the quantities requested in the directed buy orders 810 against the quantities available for purchase from the targeted participants (FIG. 18, step 900).

The directed order qualification processors 800 then pass on qualified directed orders to the buy order memory stack 830, while non-directed buy orders and sell orders are passed or are independently routed to the respective buy order and sell order memory stacks 830, 840 (FIG. 18, step 902). For clarity, the routing of non-directed orders has been omitted from FIG. 17.

Any suitable storage system or technology may be used for the memory stacks. The buy orders in the buy order memory stack 830 may be arranged according to price and time priority, with the price decreasing (or increasing) from the top down, while the sell orders in the sell order memory stack 850 may be arranged similarly, but in order of increasing price or conversely if preferred. Further, the data could be stored in some other order or fashion and sorted upon retrieval based upon price, time, or other indicia. Alternatively, the buy and sell orders could be stored in a single memory instead of in separate, dedicated buy and sell order memory stacks.

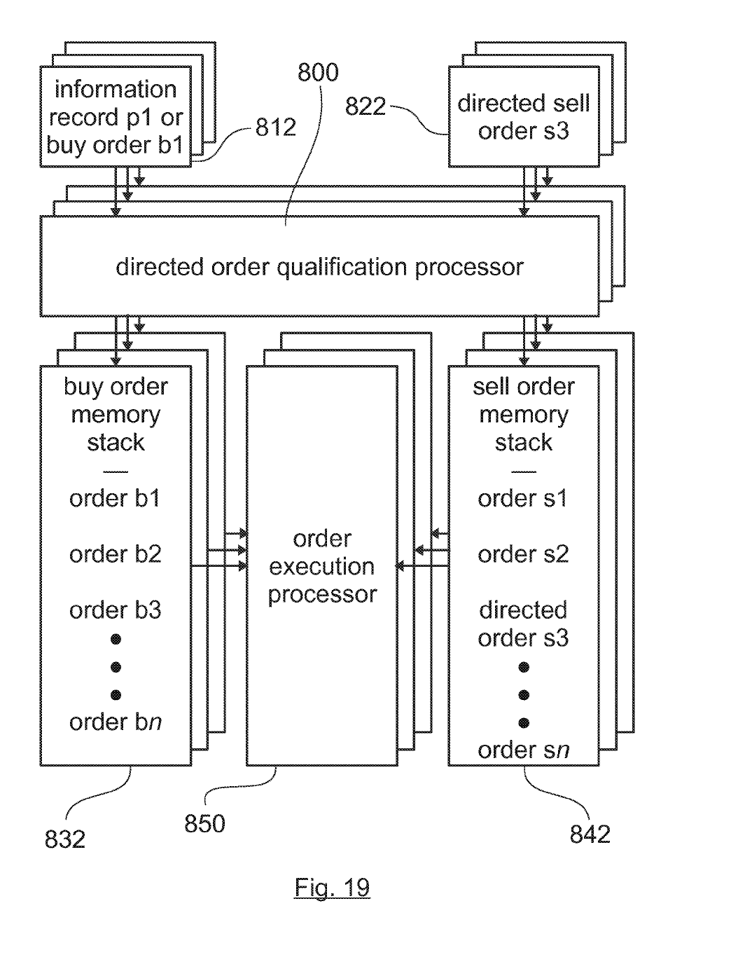

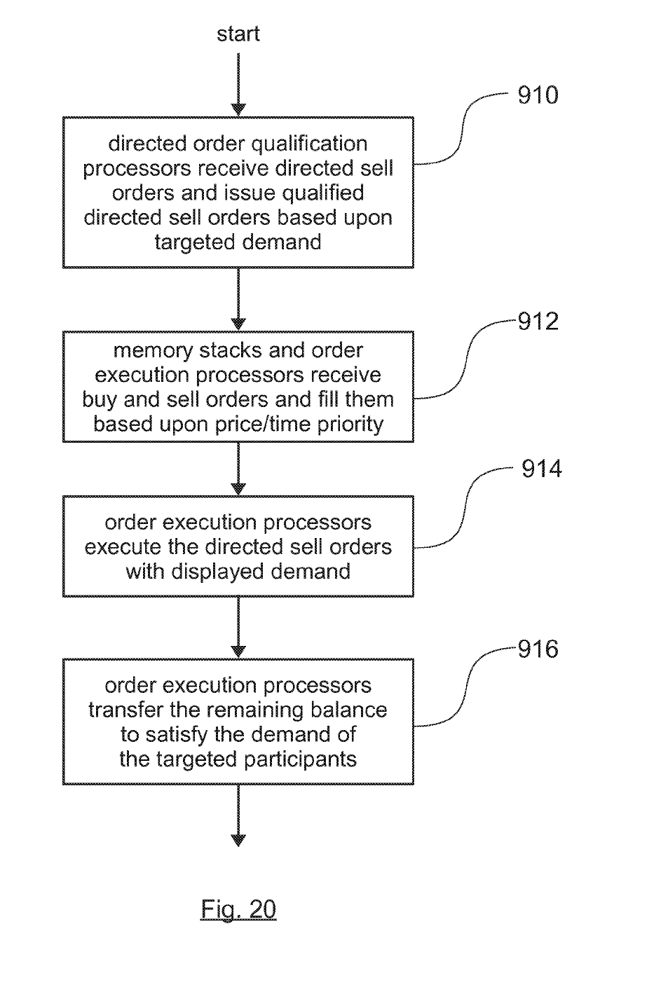

An order execution processor 850 selectively accesses the contents of the buy order and sell order memory stacks 830 and 840. The order execution processor 850 comprises comparators, or price comparison and matching modules, for comparing prices in the buy and sell orders. For buy orders, the processor 850 continually searches for sell orders having the lowest price not greater than the participant's stated purchase price; for sell orders, the processor 850 searches for the highest price not less than a participant's offering price. Once a price match occurs, the processor 850 will fill the order against standing orders until filled (FIG. 18, step 904). If a directed order is only partially filled, the order execution processor 850 will then look to any targeted participant for the predetermined quantity of additional items the targeted participant has made available (FIG. 18, step 906). A block diagram of a processing system for qualification and execution of a directed sell order, corresponding to the system of FIG. 17 and the flow chart of FIG. 18, is shown in FIG. 19 and its flow chart is shown in FIG. 20. The systems function in a fashion similar to the example above for the directed buy order. Similar to FIG. 17, non-directed sell orders in FIG. 19 effectively pass through the directed order qualification processors 800 or are routed directly to the sell order memory stacks 842, and for clarity, this routing been omitted from the figure.

An Order Execution Processor

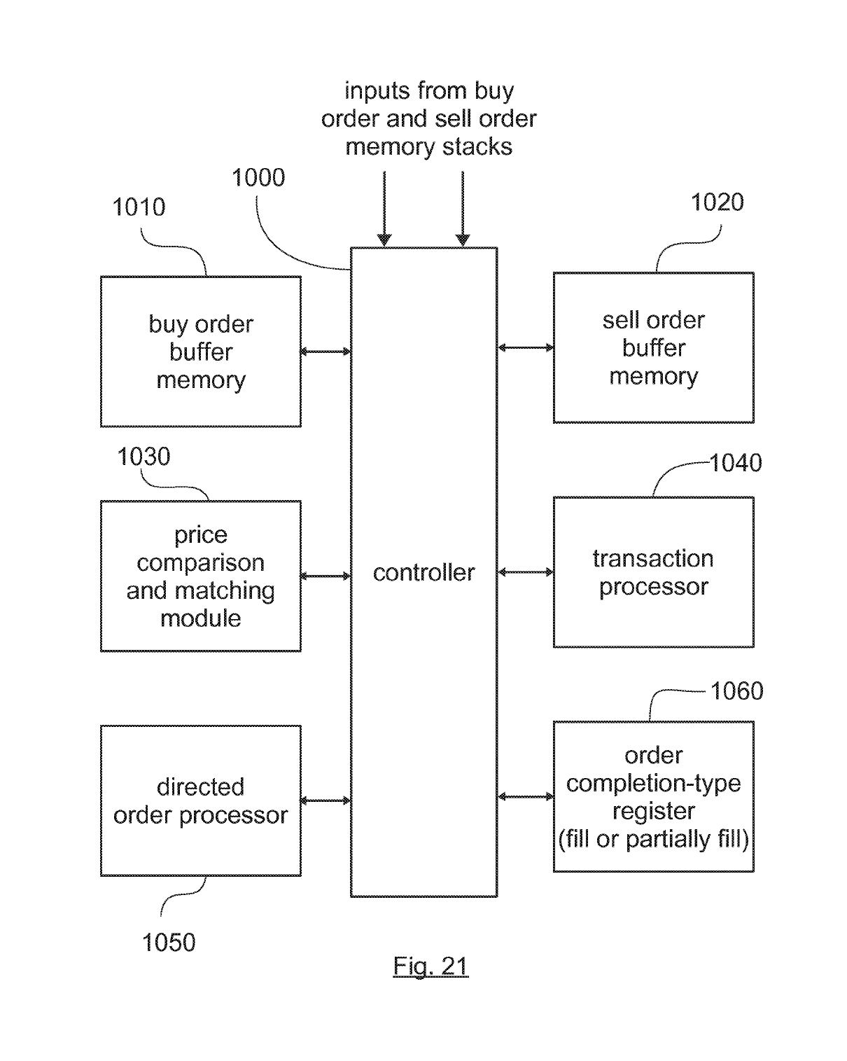

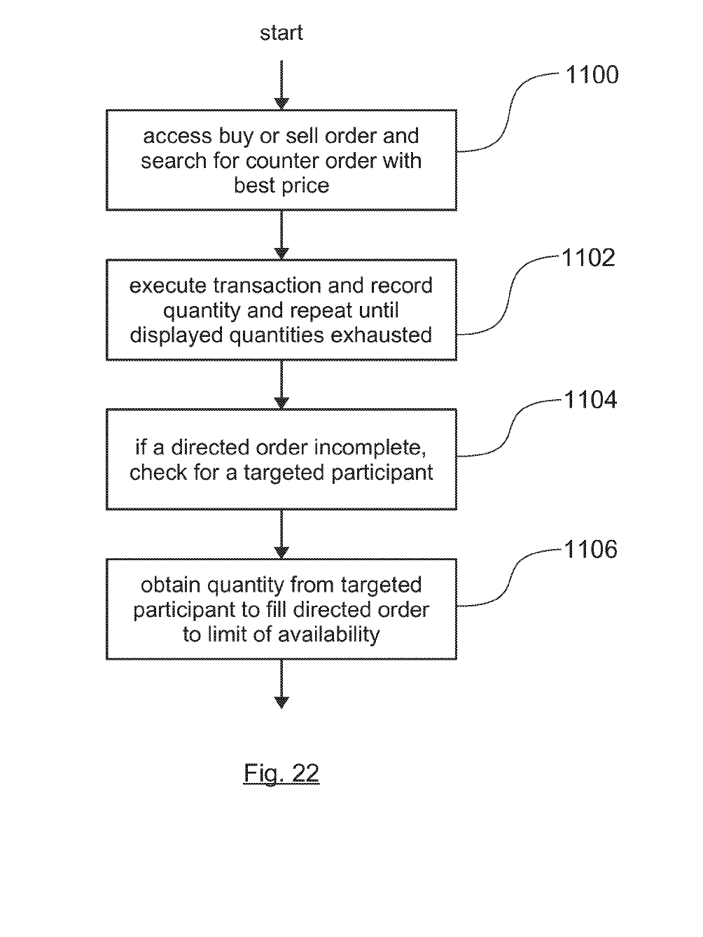

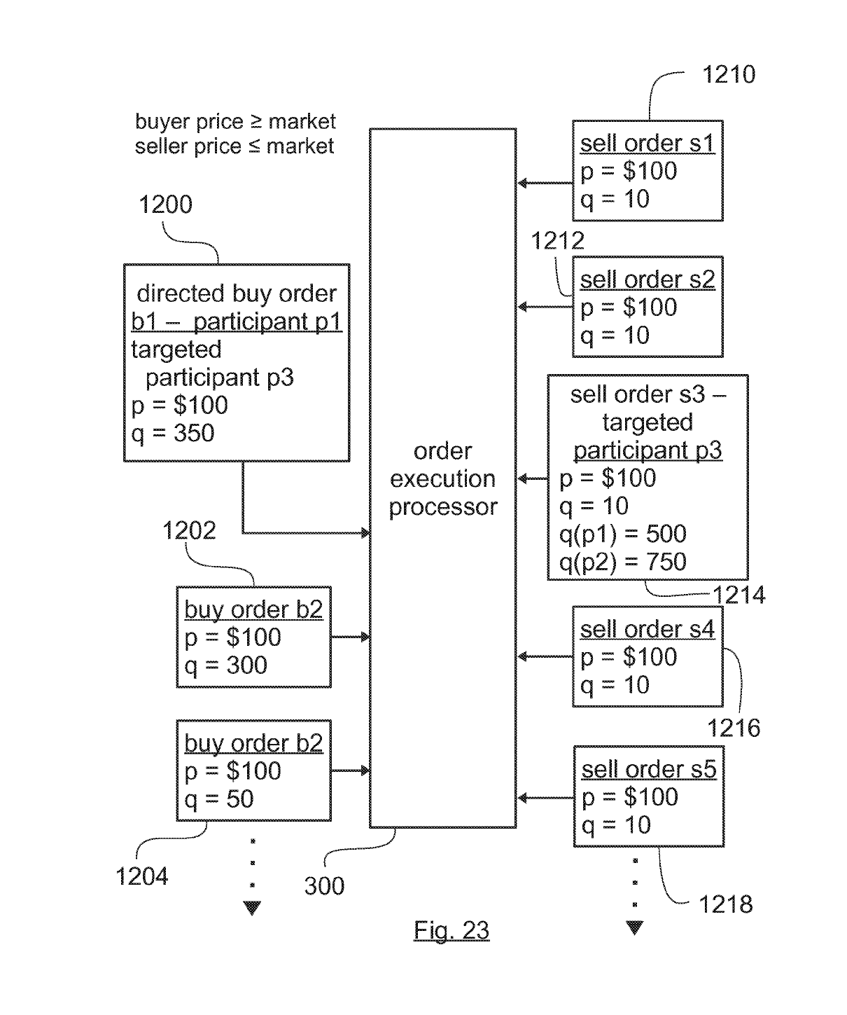

The components of an order execution processor 850 are shown in FIG. 21, and its operation is outlined in the flow chart in FIG. 22. A controller 1000 receives order data from the buy order and/or sell order memory stacks, and may hold data in buy order and sell order buffer memories 1010 and 1020, as needed to handle the data, or directly access order data from the memory stacks.

The controller 1000 utilizes a price comparison and matching module 1030 to test for a price at which a transaction may be consummated, seeking the lowest price for a participant seeking to buy and the highest price for which a participant may sell the item (FIG. 22, step 1100). When the price comparison and matching module 1030 determines that a price match exists between two parties, a transaction processor 1040 will execute the transaction, and tally the number of units sold against the buy or sell order quantity (FIG. 22, step 1102).

After the displayed quantities are exhausted for the transactions at a given price, a directed order processor 1050 will attempt to complete any open directed orders by checking for the presence of a corresponding targeted participant (FIG. 22, step 1104). Finally, an order completion-type register 1060 may note whether the order is designated to be completely or partially filled (FIG. 22, step 1106).

An Alternative Configuration

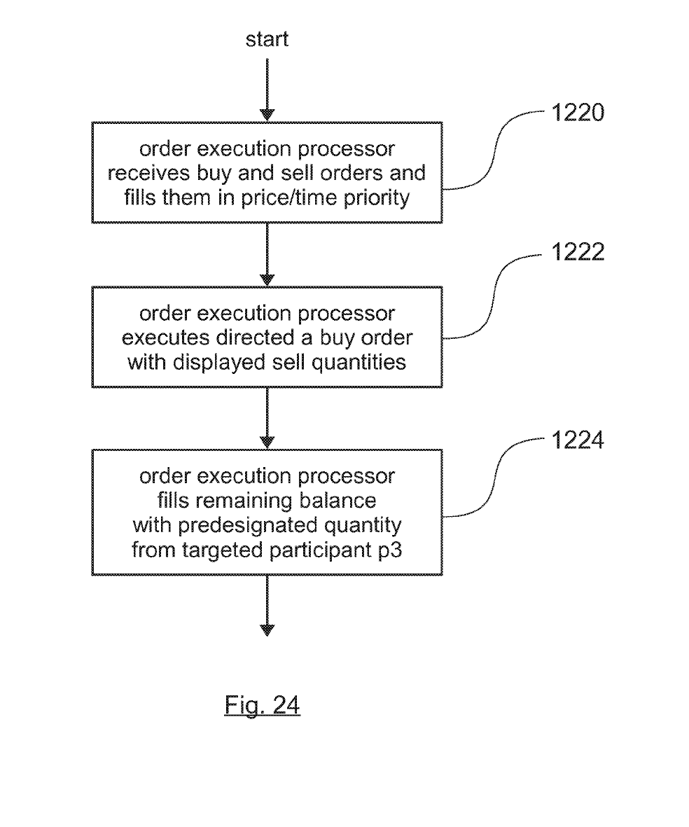

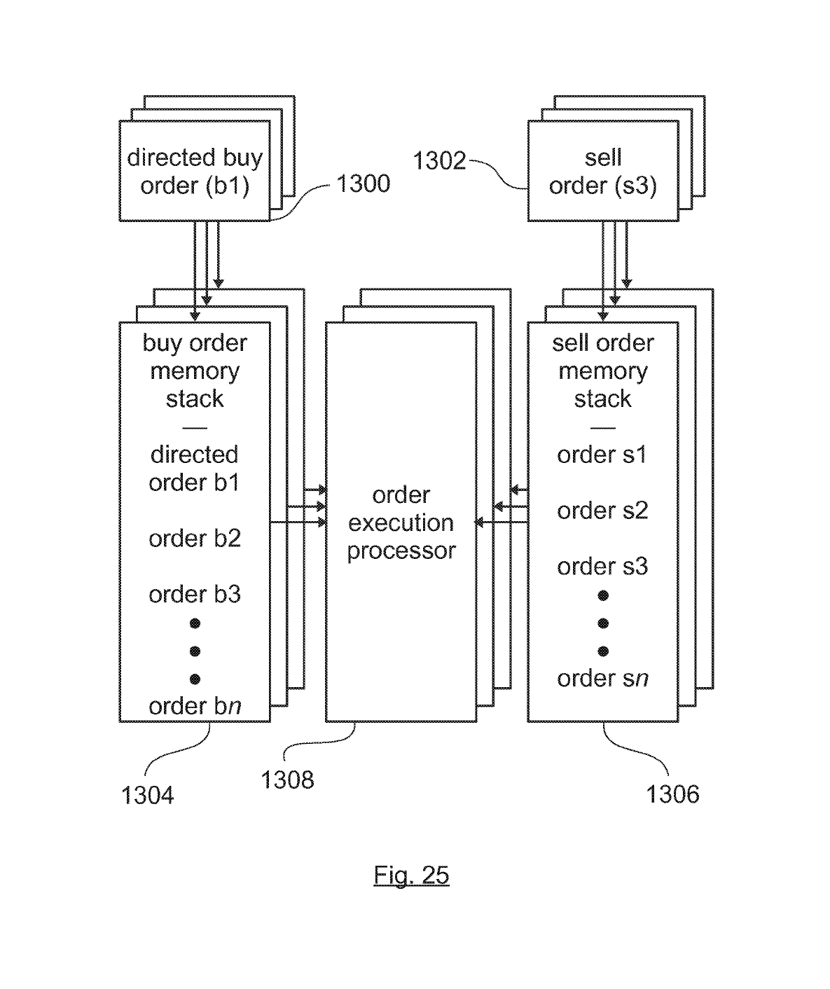

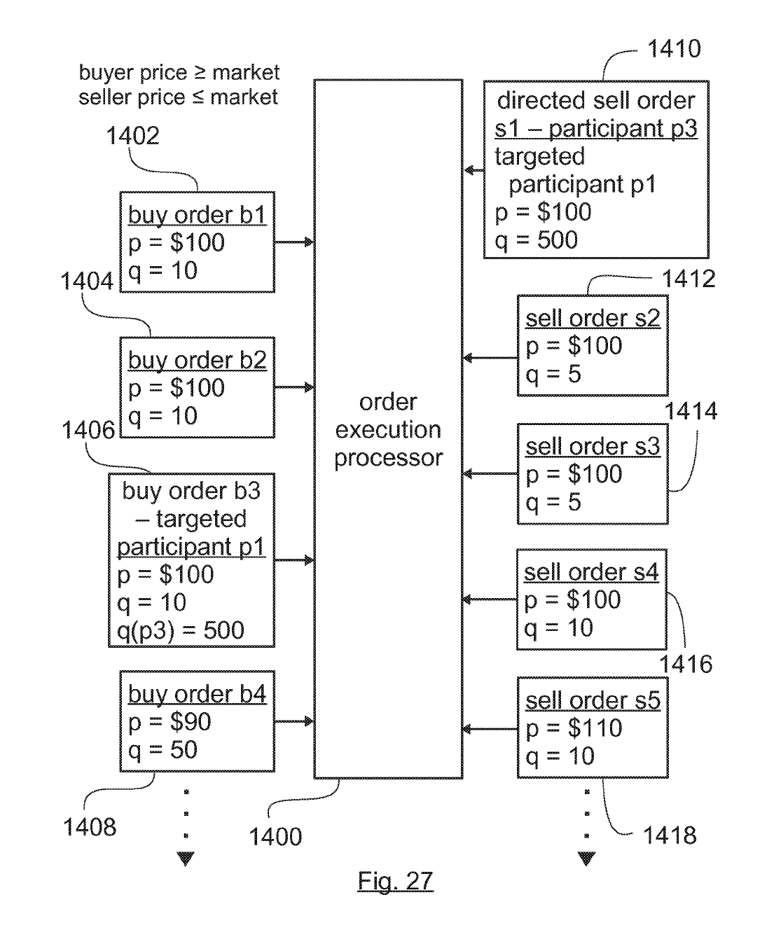

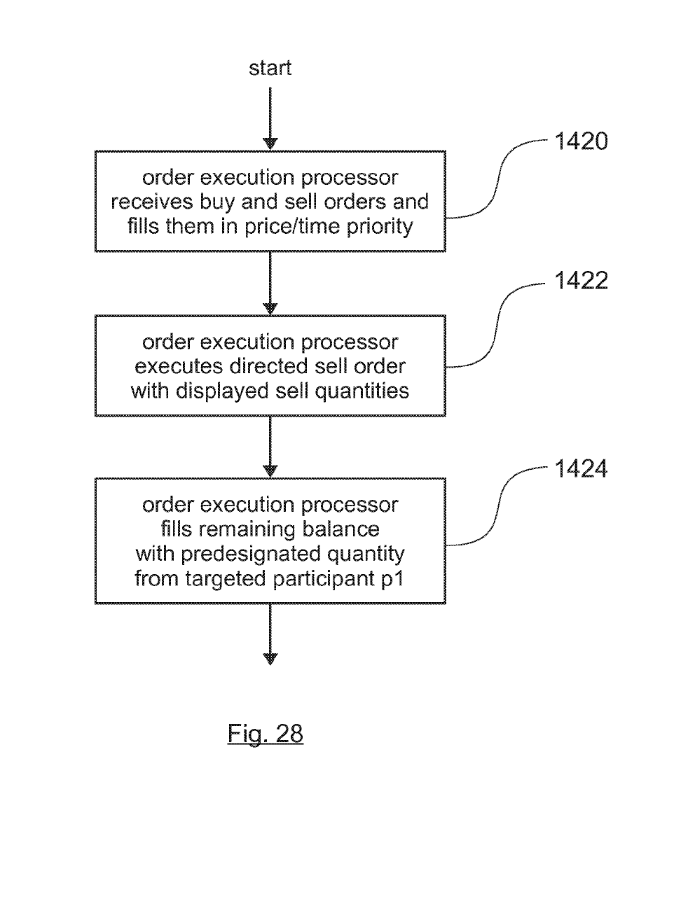

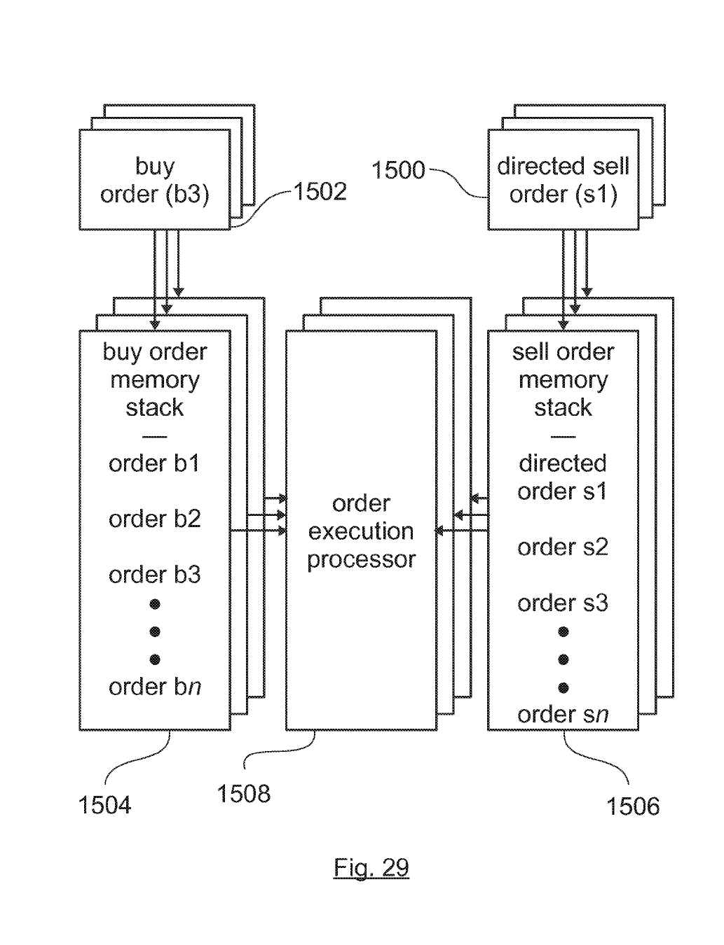

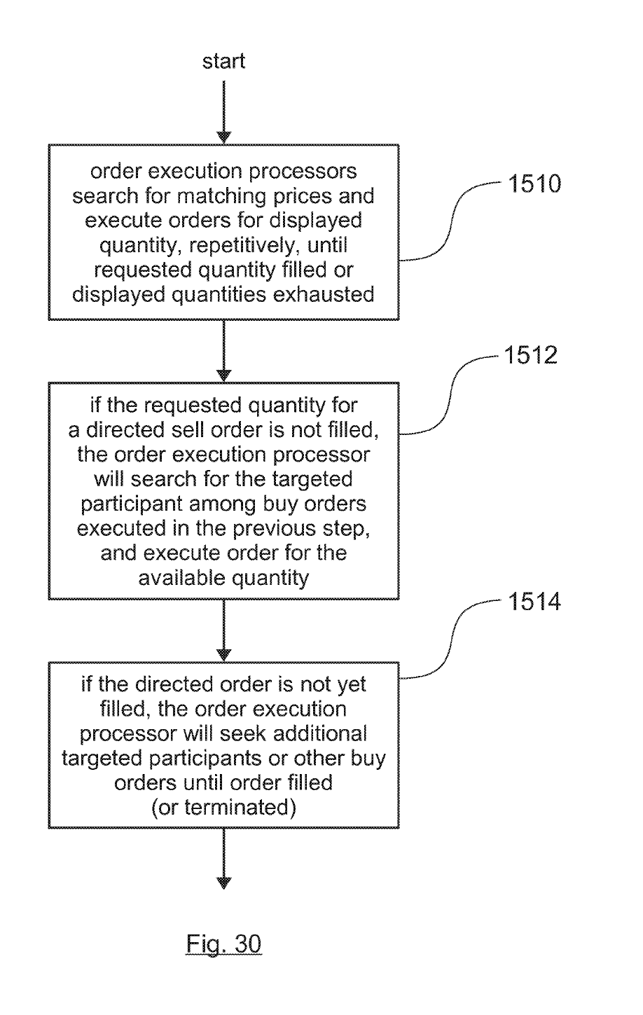

In the preceding discussion, directed orders are qualified by the predetermined quantities allocated for purchase or sale and, optionally, by the credit worthiness of one or more of the participants. In another arrangement, directed orders proceed directly to the order execution processor without a preliminary qualification (and therefore no setting of a qualified quantity q′) as shown in FIGS. 23-30. The systems and processes for executing a directed buy order are illustrated in FIGS. 23-26 and the systems and processes for executing a directed sell order are shown in FIGS. 27-30.

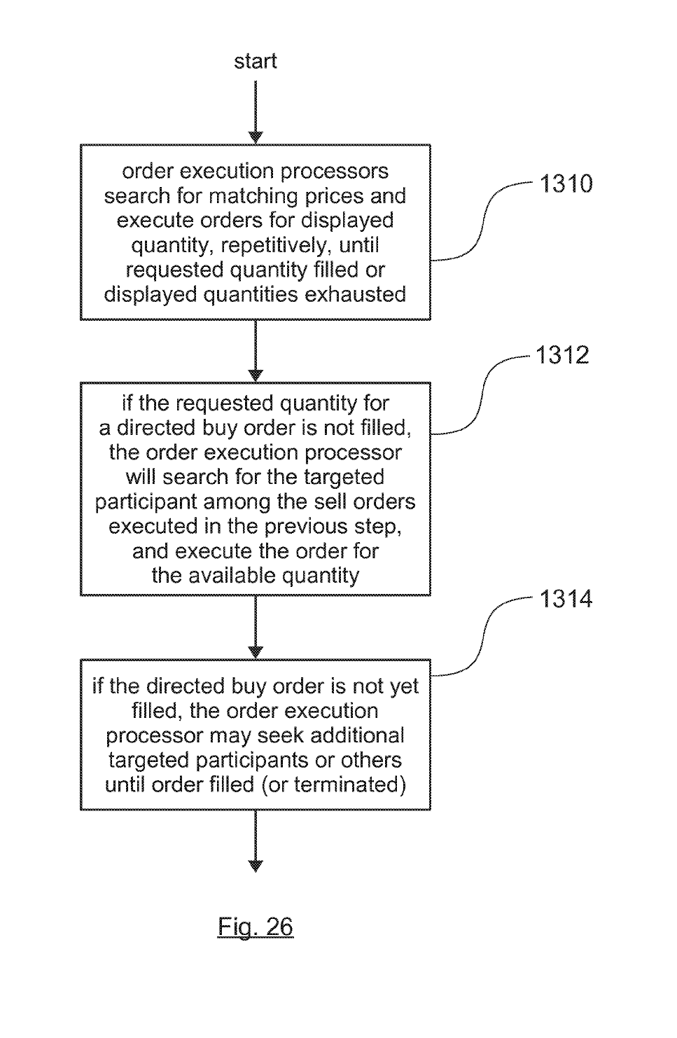

When a buy order arrives, the order execution processor (FIG. 23, 300; FIG. 25, 1308) searches for a price match or, if lower, the lowest price presented among the sell orders present (FIG. 23, 1210-18), and proceed to fill the order until the desired quantity is reached or the price exceeds the participant's limit. If the latter case occurs for a directed buy order (FIG. 23, 1200; FIG. 25, 1300), the system will consult the order for the identity of a targeted participant that may have additional quantities and then determine whether the targeted participant is present in the sell orders reached to this point, that is, displaying a price not higher than the relationship participant is willing to pay. If the targeted participant is present, the processor will execute sales from the targeted participant's additional quantities up to that amount or the pre-designated limit (FIG. 23, 1214, q(p1)), whichever is lower (FIG. 25, 1308; FIG. 26, step 1312).

An order execution processor and a directed order transaction system for executing a directed sell order are shown in FIGS. 27-30, together with their associated flow charts, and function in a manner corresponding to the directed buy order configuration illustrated in FIGS. 23-26 as explained above.

### INDUSTRIAL APPLICABILITY

The systems and methods discussed thus far may be employed to transact sales, conduct electronic commerce, and provide directed orders for a wide variety of items, including hard and soft goods, energy (power), water, and financial instruments (e.g., commodities, equities, futures, options, and swaps). Depending on the nature of the item sold in a transaction, the directed orders may provide additional inventory, availability, capacity, or liquidity, as appropriate. Additionally, because of their ability to rapidly execute transactions at the most favorable prices without human intervention, the systems and methods will help maintain a firm, orderly, and price-transparent market.

Related technology in the financial market has been discussed in U.S. Pat. Nos. 7,587,346; 7,801,795; 7,949,596; 8,296,216; 8,301,539; and 8,311,930; and U.S. Pat. App. Publ. Nos. 2007/0078753 and 2013/0013481, incorporated herein by reference.

What is claimed is:

1. A system for allocating quantities of an item in a marketplace, comprising:
buy and sell orders generated by participants in the marketplace, the buy and sell orders comprising the participant's identity, item identity, price, and a displayed quantity,
at least one buy or sell order further comprising a targeted order generated by a targeted participant having a pre-existing relationship with at least one relationship participant, the targeted order comprising the targeted participant's identity, item identity, price, displayed quantity, the relationship participant identities, and quantities available for fulfillment of directed orders from relationship participants, and
at least one buy or sell order further comprising a directed buy or sell order generated by a relationship participant, comprising the relationship participant's identity, item identity, price, displayed quantity, and the targeted participant's identity; and
a memory for storing the buy and sell orders; and
at least one order execution processor, the processor comprising
a price comparison and matching module for comparing prices of the stored buy and sell order and detecting orders comprising matching prices;
a transaction processor, responsive to the price comparison and matching module, for executing transactions between matched buy and sell orders; and
a directed order processor for obtaining quantities from a targeted order to fill incomplete directed orders generated by the relationship participant.

2. A system as set forth in claim 1, further comprising
a buy order memory stack comprising buy orders; and
a sell order memory stack comprising sell orders.

3. A system as set forth in claim 1, where the buy and sell orders are stored in price and time priority.

4. A system as set forth in claim 1, further comprising
a directed order qualification processor comprising:
inputs for receiving directed orders and targeted participant allocated quantity information;
a quantity comparison module for comparing a participant requested quantity and a targeted participant allocated quantity; and
a qualified directed order generator, responsive to the quantity comparison module, for generating a qualified director order comprising the targeted participant's allocated quantity.

5. A method for allocating quantities of an item in a marketplace, in an order execution processor, the marketplace comprising buy or sell order generated by participants in the marketplace, the buy and sell orders comprising the participant's identity, item identity, price, and a displayed quantity,
at least one buy or sell order further comprising a targeted order generated by a targeted participant having a pre-existing relationship with at least one relationship participant, the targeted order comprising the targeted participant's identity, item identity, price, displayed quantity, the relationship participant identities, and quantities available for fulfillment of directed orders from relationship participants, and
at least one buy or sell order further comprising a directed buy or sell order generated by a relationship participant, comprising the relationship participant's identity, item identity, price, displayed quantity, and the targeted participant's identity;
the method comprising:
storing the buy and sell orders in memory;
providing the buy and sell orders to the order execution processor,
the processor comprising
a price comparison and matching module for comparing prices of the stored buy and sell order and detecting orders comprising matching prices;
a transaction processor, responsive to the price comparison and matching module, for executing transactions between matched buy and sell orders; and
a directed order processor for obtaining quantities from a targeted order to fill incomplete directed orders generated by the relationship participant;
in the price comparison and matching module, comparing prices of the stored buy and sell order and detecting orders comprising matching prices;
in the transaction processor, in response to the price comparison and matching, executing transactions between matched buy and sell orders; and
in a directed order processor, obtaining quantities from a targeted order to fill incomplete directed orders generated by the relationship participant.

6. A method as set forth in claim 5, further comprising storing the buy orders and sell orders in respective buy and sell order memory stacks.

7. A method as set forth in claim 5, further comprising storing the buy orders and sell orders in price and time priority.

8. A method as set forth in claim 5, further comprising qualifying a directed order, comprising
providing directed orders and targeted participant allocated quantity information to a directed order qualification processor comprising
inputs for receiving directed orders and targeted participant allocated quantity information;
a quantity comparison module for comparing a participant requested quantity and a targeted participant allocated quantity; and
a qualified directed order generator, responsive to the quantity comparison module, for generating a qualified director order comprising the targeted participant's allocated quantity;
in the quantity comparison module, comparing the requested quantity and targeted order allocated quantity; and
in the qualified directed order generator, in response to comparing the quantity and targeted order allocated quantity, generating a qualified directed order comprising a qualified quantity not greater than the targeted order's allocated quantity.

9. A method for providing quantities of an item to one or more relationship participants in a marketplace by a targeted participant, comprising:
creating an order offering to buy or sell, respectively, a fixed, displayed quantity of the item at a set price; and
setting non-displayed quantities of the item the targeted participant will buy or sell, respectively, from one or more relationship participants at the set price.
